(19) United States
(12) Patent Application Publication
(10) Pub. No.: US 2016/0232825 A1
(43) Pub. Date: Aug. 11, 2016

(54) 3D DISPLAY DEVICE AND DRIVING METHOD THEREOF

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Wenqing Zhao, Beijing (CN); Xue Dong, Beijing (CN); Hailin Xue, Beijing (CN); Haisheng Wang, Beijing (CN); Ming Yang, Beijing (CN)

(21) Appl. No.: 14/743,953

(22) Filed: Jun. 18, 2015

(30) Foreign Application Priority Data
Feb. 11, 2015 (CH) 201510072619.8

(51) Int. Cl. G09G 3/00; G09G 3/36; G09G 3/38; H04N 13/04

(52) U.S. Cl. CPC G09G 3/003; H04N 13/0497; H04N 13/0409; H04N 13/0422; G09G 3/3696; G09G 3/38; G09G 2300/0452; G09G 2320/0266

(57) ABSTRACT

The present invention provides a 3D display device and a driving method thereof, which relates to the field of display technology, being capable of mitigating or eliminating the problem of graininess of image caused by large difference between rates of resolution decrease in a row direction and a column direction, so as to improve display quality. Wherein the 3D display device comprises a display driving module, a display panel, a barrier driving module and a parallax barrier, the sum of areas of the light shielding zones and the sum of areas of the light transmissive zones in each row of grating regions are both greater than 0, the sum of areas of the light shielding zones and the sum of areas of the light transmissive zones in each column of grating regions are both greater than 0, such that the sum of areas of sub-pixels shielded by the light shielding zones and the sum of areas of sub-pixels exposed by the light transmissive zones in each row of sub-pixel regions are both greater than 0, the sum of areas of sub-pixels shielded by the light shielding zones and the sum of areas of sub-pixels exposed by the light transmissive zones in each column of sub-pixel regions are both greater than 0.

### FIELD OF THE INVENTION

The present invention relates to the field of display technology, particularly to a 3D display device and a driving method thereof.

### BACKGROUND OF THE INVENTION

With continuous improvement of the panel display technology, 3D display technology has become one of the hotspots studied in the present field. The current 3D display technology mainly includes two implementing modes of bare type and spectacle type, while the spectacle 3D display technology requires special glasses, which is not convenient to carry, hence, the tablet PC and mobile phone products pay more attention to development of bare 3D. The implementing modes of the bare 3D mainly include parallel barrier and cylindrical lens, wherein the cylindrical lens is generally incompatible with the process of liquid crystal display (LCD) or organic light-emitting diode (OLED) display, so more panel manufacturers are developing the parallel barrier type bare 3D display technology.

The parallel barrier type bare 3D display superposes a layer of liquid crystal grating on the surface of the display panel, this layer of liquid crystal grating is Twisted Nematic (TN) type, all the regions are light transmissive under the state that no power is applied, which is in a constant white state, alternately arranged light shielding zones and light transmissive zones are formed when power is applied, which presents alternate display of black and white. Due to the shielding effect of the liquid crystal grating to the sub-pixels, and the certain distance between the left eye and the right eye of the human being, the left eye of the observer can only see the left eye images displayed by the odd columns of pixels, and cannot see the right eye images displayed by the even columns of pixels, while the right eye can only see the right eye images displayed by the even columns of pixels, and cannot see the left eye images displayed by the odd columns of pixels, the left eye images and the right eye images are superimposed and synthesized in the brain to enable the observer to generate depth perception so as to realize 3D display.

Generally, the light shielding zones and the light transmissive zones in the liquid crystal grating are in strip shape, and in alternate arrangement perpendicularly (i.e., along the column direction of the sub-pixel arrangement). However, it is found in the actual applications that the 3D display device comprising the conventional liquid crystal grating may have the problem of graininess when displaying the images, and the display quality is relatively bad.

### SUMMARY OF THE INVENTION

In order to overcome defects in the prior art, the technical problem to be solved by the present invention is: to provide a 3D display device and a driving method thereof, so as to improve image display quality of the 3D display device.

To achieve the above object, the present invention adopts the following technical solutions:

A first aspect of the present invention provides a 3D display device, comprising: a display driving module for outputting a left eye image signal and a right eye image signal; a display panel connected with the display driving module, comprising a plurality of sub-pixels, one part of the plurality of sub-pixels receiving the left eye image signal, the other part of the plurality of sub-pixels receiving the right eye image signal; the sub-pixels receiving the left eye image signal being first sub-pixels, the sub-pixels receiving the right eye image signal being second sub-pixels; a barrier driving module for outputting a driving voltage signal; a parallax barrier connected with the barrier driving module and superposed on the display panel, the parallax barrier comprising a plurality of grating regions, the plurality of grating regions forming a plurality of light shielding zones and a plurality of light transmissive zones under the driving of the driving voltage signal, such that, for the left eye of an observer, respective light shielding zones shield respective second sub-pixels and respective light transmissive zones expose respective first sub-pixels, for the right eye of an observer, respective light shielding zones shield respective first sub-pixels and respective light transmissive zones expose respective second sub-pixels; wherein a sum of areas of the light shielding zones and a sum of areas of the light transmissive zones in each row of grating regions are both greater than 0, a sum of areas of the light shielding zones and a sum of areas of the light transmissive zones in each column of grating regions are both greater than 0, such that a sum of areas of sub-pixels shielded by the light shielding zones and a sum of areas of sub-pixels exposed by the light transmissive zones in each row of sub-pixel regions are both greater than 0, a sum of areas of sub-pixels shielded by the light shielding zones and a sum of areas of sub-pixels exposed by the light transmissive zones in each column of sub-pixel regions are both greater than 0; the width of each row of grating regions is equal to the length of a unit light shielding zone, the width of each column of grating regions is equal to the width of a unit light shielding zone, the width of each row of sub-pixel regions is equal to the length of a unit sub-pixel, the width of each column of sub-pixel regions is equal to the width of a unit sub-pixel.

Optionally, the sum of the areas of the light shielding zones and the sum of the areas of the light transmissive zones in each row of grating regions are equal, such that the sum of the areas of the sub-pixels shielded by the light shielding zones and the sum of the areas of the sub-pixels exposed by the light transmissive zones in each row of sub-pixel regions are equal.

Optionally, for the left eye of the observer, one light shielding zone shields one second sub-pixel, one light transmissive zone exposes one first sub-pixel; for the right eye of the observer, one light shielding zone shields one first sub-pixel, one light transmissive zone exposes a second sub-pixel.

Optionally, the sub-pixels of the display panel are arranged in a plurality of rows, each row comprising a plurality of arrangement cycles, the colors of the sub-pixels in each arrangement cycle are different from one another, the first sub-pixels and the second sub-pixels in each row are arranged alternately; the light shielding zones and the light transmissive zones in each row of grating regions in the parallax barrier are arranged alternately.

Optionally, the sum of the areas of the light shielding zones and the sum of the areas of the light transmissive zones in each column of grating regions are equal, such that the sum of the areas of the sub-pixels shielded by the light shielding zones and the sum of the areas of the sub-pixels exposed by the light transmissive zones in each column of sub-pixel regions are equal.

Optionally, the sub-pixels of the display panel are arranged in a matrix, all the sub-pixels in each column have the same color or adjacent sub-pixels in each column have different colors, the first sub-pixels and the second sub-pixels in each column are arranged alternately; the light shielding zones and the light transmissive zones in each column of grating regions in the parallax barrier are arranged alternately.

Optionally, adjacent sub-pixels of the display panel in the column direction have different colors, a next row of sub-pixels shift to the left for an amount less than the width of a unit sub-pixel relative to a previous row of sub-pixels; light shielding zones in a next row of grating regions shift to the left for an amount less than the width of a unit light shielding zone relative to light shielding zones in a previous row of grating regions in the parallax barrier; or, adjacent sub-pixels of the display panel in the column direction have different colors, a next row of sub-pixels shift to the right for an amount less than the width of a unit sub-pixel relative to a previous row of sub-pixels; light shielding zones in a next row of grating regions shift to the right for an amount less than the width of a unit light shielding zone relative to light shielding zones in a previous row of grating regions in the parallax barrier.

Optionally, the ratio of a sum of areas of the light shielding zones and a sum of areas of the light transmissive zones in odd columns of grating regions is 1:3, the ratio of a sum of areas of the light shielding zones and a sum of areas of the light transmissive zones in even columns of grating regions is 3:1, such that the ratio of a sum of areas of the sub-pixels shielded by the light shielding zones and a sum of areas of the sub-pixels exposed by the light transmissive zones in odd columns of sub-pixel regions is 1:3, the ratio of a sum of areas of the sub-pixels shielded by the light shielding zones and a sum of areas of the sub-pixels exposed by the light transmissive zones in even columns of sub-pixel regions is 3:1.

Optionally, adjacent sub-pixels of the display panel in the column direction have different colors, even rows of sub-pixels shift to the left for an amount less than the width of a unit sub-pixel relative to odd rows of sub-pixels; light shielding zones in even rows of grating regions shift to the left for an amount less than the width of a unit light shielding zone relative to light shielding zones in odd rows of grating regions in the parallax barrier; or, adjacent sub-pixels of the display panel in the column direction have different colors, even rows of sub-pixels shift to the right for an amount less than the width of a unit sub-pixel relative to odd rows of sub-pixels; light shielding zones in even rows of grating regions shift to the right for an amount less than the width of a unit light shielding zone relative to light shielding zones in odd rows of grating regions in the parallax barrier.

Optionally, the display panel comprises sub-pixels of three colors of red, green and blue.

Optionally, the ratio of the width and the length of the sub-pixel is 1:3˜1:1.

Optionally, the barrier driving module is used for outputting a first driving voltage signal and a second driving voltage signal; the parallax barrier comprises a liquid crystal layer and a first electrode layer and a second electrode layer arranged at two sides of the liquid crystal layer respectively; or, wherein the barrier driving module is used for outputting a first driving voltage signal and a second driving voltage signal; the parallax barrier comprises an electrochromic layer and a first electrode layer and a second electrode layer arranged at two sides of the electrochromic layer respectively; wherein the first electrode layer receives the first driving voltage signal, and the second electrode layer receives the second driving voltage signal.

A second aspect of the present invention provides a driving method of a 3D display device for driving the 3D display device stated above, the driving method comprising: applying a left eye image signal to one part of sub-pixels of the display panel of the 3D display device, applying a right eye image signal to the other part of sub-pixels of the display panel of the 3D display device; the sub-pixels applied with the left eye image signal being first sub-pixels, the sub-pixels applied with the right eye image signal being second sub-pixels; applying a driving voltage signal to the parallax barrier of the 3D display device, to enable the plurality of grating regions of the parallax barrier to form a plurality of light shielding zones and a plurality of light transmissive zones, such that, for the left eye of an observer, respective light shielding zones shield respective second sub-pixels and respective light transmissive zones expose respective first sub-pixels, for the right eye of an observer, respective light shielding zones shield respective first sub-pixels and respective light transmissive zones expose respective second sub-pixels; wherein a sum of areas of the light shielding zones and a sum of areas of the light transmissive zones in each row of grating regions are both greater than 0, a sum of areas of the light shielding zones and a sum of areas of the light transmissive zones in each column of grating regions are both greater than 0, such that a sum of areas of sub-pixels shielded by the light shielding zones and a sum of areas of sub-pixels exposed by the light transmissive zones in each row of sub-pixel regions are both greater than 0, a sum of areas of sub-pixels shielded by the light shielding zones and a sum of areas of sub-pixels exposed by the light transmissive zones in each column of sub-pixel regions are both greater than 0; the width of each row of grating regions is equal to the length of a unit light shielding zone, the width of each column of grating regions is equal to the width of a unit light shielding zone, the width of each row of sub-pixel regions is equal to the length of a unit sub-pixel, the width of each column of sub-pixel regions is equal to the width of a unit sub-pixel.

Optionally, the sum of the areas of the light shielding zones and the sum of the areas of the light transmissive zones in each row of grating regions are equal, such that the sum of the areas of the sub-pixels shielded by the light shielding zones and the sum of the areas of the sub-pixels exposed by the light transmissive zones in each row of sub-pixel regions are equal.

Optionally, the sum of the areas of the light shielding zones and the sum of the areas of the light transmissive zones in each column of grating regions are equal, such that the sum of the areas of the sub-pixels shielded by the light shielding zones and the sum of the areas of the sub-pixels exposed by the light transmissive zones in each column of sub-pixel regions are equal.

Optionally, the ratio of a sum of areas of the light shielding zones and a sum of areas of the light transmissive zones in odd columns of grating regions is 1:3, the ratio of a sum of areas of the light shielding zones and a sum of areas of the light transmissive zones in even columns of grating regions is 3:1, such that the ratio of a sum of areas of the sub-pixels shielded by the light shielding zones and a sum of areas of the sub-pixels exposed by the light transmissive zones in odd columns of sub-pixel regions is 1:3, the ratio of a sum of areas of the sub-pixels shielded by the light shielding zones and a sum of areas of the sub-pixels exposed by the light transmissive zones in even columns of sub-pixel regions is 3:1.

In the 3D display device and the driving method thereof provided by the present invention, 3D display is realized by arranging a display driving module, a display panel, a barrier driving module and a parallax barrier, wherein a sum of areas of the light shielding zones and a sum of areas of the light transmissive zones in each row of grating regions of the parallax barrier are both greater than 0, a sum of areas of the light shielding zones and a sum of areas of the light transmissive zones in each column of grating regions are both greater than 0, such that a sum of areas of sub-pixels shielded by the light shielding zones and a sum of areas of sub-pixels exposed by the light transmissive zones in each row of sub-pixel regions are both greater than 0, a sum of areas of sub-pixels shielded by the light shielding zones and a sum of areas of sub-pixels exposed by the light transmissive zones in each column of sub-pixel regions are both greater than 0, i.e., a part of sub-pixels in the row direction are shielded, a part of sub-pixels in the column direction are shielded, thereby in 3D display, rates of resolution decrease of the observed left eye image or right eye image in a row direction and in a column direction are both greater than 0, which reduces difference between the rates of resolution decrease in the row direction and the column direction, mitigates or eliminates the problem of graininess of the image caused by large difference between the rates of resolution decrease in the row direction and the column direction, and improves display quality.

### BRIEF DESCRIPTION OF DRAWINGS

In order to explain the technical solutions in the embodiments of the present invention or the prior art more clearly, the drawings to be used in the description of the embodiments or the prior art will be introduced briefly in the following, apparently, the drawings described below are only some embodiments of the present invention, for the ordinary skilled person in the art, other drawings can also be obtained from these drawings in the case of not paying any creative work.

FIG. 1 is a plan view of a liquid crystal grating in which strip-shaped light shielding zones and light transmissive zones are perpendicularly arranged in the prior art;

FIG. 2 is a plan view of a liquid crystal grating in which strip-shaped light shielding zones and light transmissive zones are obliquely arranged in the prior art;

FIG. 3˜FIG. 8 are plan views of corresponding parallax barriers and pixel arrangements of six kinds of 3D display devices provided by the embodiments of the present invention;

FIG. 9 is a lateral view of a 3D display device provided by an embodiment of the present invention;

FIG. 10 is a relationship diagram of a visual range of a 3D image and respective parameters in the 3D display device provided by an embodiment of the present invention;

Explanations of reference numbers: 11—sub-pixel; 22—liquid crystal grating, parallax barrier; 221—light shielding zone; 222—light transmissive zone; R—red sub-pixel; G—green sub-pixel; B—blue sub-pixel; 1—left eye image; 2—right eye image; M1—a row of sub-pixel regions; N1—a column of sub-pixel regions; M2—a row of grating regions; N2—a column of grating regions; 33—display panel; 223, 331, 339—polarizer; 224, 229, 332, 338—substrate; 225—first electrode layer; 226, 336—liquid crystal layer; 227, 335—sealing frame glue; 228—second electrode layer; 333—black matrix; 334—color resin; 337—pixel electrode; 44—optical adhesive; s—visual range of a 3D image; h—space between the parallax barrier and the display panel; a—distance between left and right eyes; w—width of a unit pixel.

### DETAILED DESCRIPTION OF THE INVENTION

Just as stated in the BACKGROUND OF THE INVENTION, there would be a problem of graininess when performing 3D display using the conventional 3D display device of liquid crystal gratings in which strip-shaped light shielding zones and light transmissive zones are perpendicularly (i.e., along the column direction of sub-pixel arrangement) arranged in the prior art, the inventor finds from research that one of the reasons that result in the preceding problem lies in:

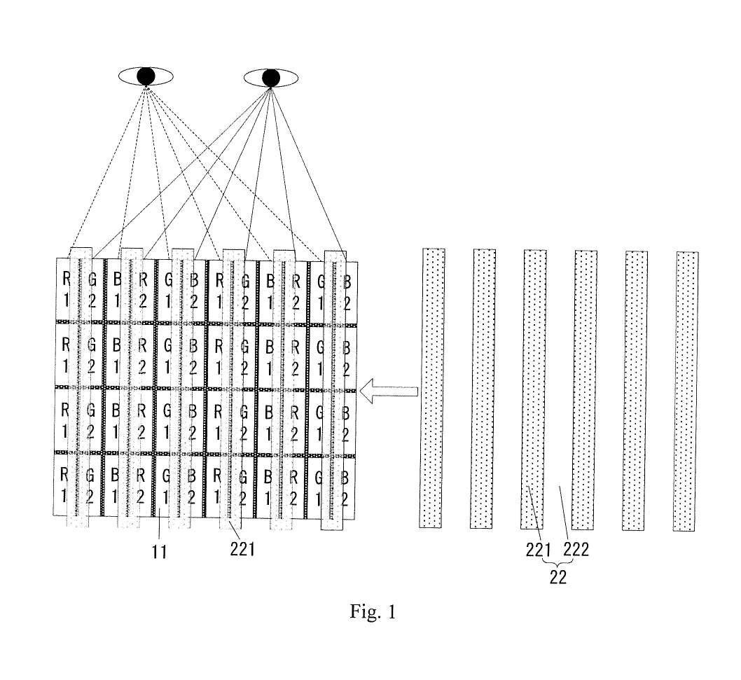

As shown in FIG. 1, the light shielding zones 221 (in order to show the shielding effect of the light shielding zones 221 to the sub-pixels 11, translucent processing is performed to the light shielding zones 221 in the view at the left side of FIG. 1) and the light transmissive zones 222 in the liquid crystal grating 22 are in strip shape, the light shielding zones 221 and the light transmissive zones 222 are arranged perpendicularly (i.e., along the column direction of the arrangement of sub-pixels 11) and alternately, half of the sub-pixels in the row direction are shielded, it can be deemed that the rate of resolution decrease in the row direction is 50%, the sub-pixels in the column direction are not shielded, it can be deemed that the rate of resolution decrease in the column direction is 0. Since the difference between the rates of resolution decrease in the row direction and the column direction is 50%, the difference is too large, the resolution decrease in the row direction and the column direction is severely uneven, thus resulting in graininess of the observed image, and the display quality is reduced.

On the basis of this, the inventor provides a 3D display device, the 3D display device comprising:

a display driving module for outputting a left eye image signal and a right eye image signal;

a display panel connected with the display driving module, comprising a plurality of sub-pixels, one part of the plurality of sub-pixels receiving the left eye image signal, the other part of the plurality of sub-pixels receiving the right eye image signal; the sub-pixels receiving the left eye image signal being first sub-pixels, the sub-pixels receiving the right eye image signal being second sub-pixels;

a barrier driving module for outputting a driving voltage signal;

a parallax barrier connected with the barrier driving module and superposed on the display panel, the parallax barrier comprising a plurality of grating regions, the plurality of grating regions forming a plurality of light shielding zones and a plurality of light transmissive zones under the driving of the driving voltage signal, such that, for the left eye of an observer, respective light shielding zones shield respective second sub-pixels and respective light transmissive zones expose respective first sub-pixels, for the right eye of an observer, respective light shielding zones shield respective first sub-pixels and respective light transmissive zones expose respective second sub-pixels.

The embodiment of the present invention further provides a driving method for driving the preceding 3D display device, the driving method comprising:

applying a left eye image signal to one part of sub-pixels of the display panel of the 3D display device, applying a right eye image signal to the other part of sub-pixels of the display panel of the 3D display device; the sub-pixels applied with the left eye image signal being first sub-pixels, the sub-pixels applied with the right eye image signal being second sub-pixels;

applying a driving voltage signal to the parallax barrier of the 3D display device, to enable the plurality of grating regions of the parallax barrier to form a plurality of light shielding zones and a plurality of light transmissive zones, such that, for the left eye of an observer, respective light shielding zones shield respective second sub-pixels and respective light transmissive zones expose respective first sub-pixels, for the right eye of an observer, respective light shielding zones shield respective first sub-pixels and respective light transmissive zones expose respective second sub-pixels.

Moreover, in the above 3D display device and the driving method thereof, a sum of areas of the light shielding zones and a sum of areas of the light transmissive zones in each row of grating regions are both greater than 0, a sum of areas of the light shielding zones and a sum of areas of the light transmissive zones in each column of grating regions are both greater than 0, such that a sum of areas of sub-pixels shielded by the light shielding zones and a sum of areas of sub-pixels exposed by the light transmissive zones in each row of sub-pixel regions are both greater than 0, a sum of areas of sub-pixels shielded by the light shielding zones and a sum of areas of sub-pixels exposed by the light transmissive zones in each column of sub-pixel regions are both greater than 0.

It should be noted that the width of each row of grating regions is equal to the length of a unit light shielding zone, the width of each column of grating regions is equal to the width of a unit light shielding zone, the width of each row of sub-pixel regions is equal to the length of a unit sub-pixel, the width of each column of sub-pixel regions is equal to the width of a unit sub-pixel.

Using the above 3D display device and the driving method thereof can realize that a part of pixel areas in both the row direction and the column directions are shielded, thereby in 3D display, the rates of resolution decrease of the observed left eye image or right eye image in the row direction and the column direction are both greater than 0, the difference between the two is reduced relative to the prior art, so as to mitigate or eliminate the problem of graininess of the image caused by large difference between the rates of resolution decrease in the row direction and the column direction when using perpendicular gratings, and improve display quality.

The above is the core idea of the present invention. In order to make the above objects, characteristics and advantages of the present invention more obvious and understandable, the technical solutions in the embodiments of the present invention will be described clearly and completely in combination with the drawings in the embodiments of the present invention in the following. Apparently, the embodiments described are only a part rather than all of the embodiments of the present invention. Other embodiments obtained by the ordinary skilled person in the art based on the embodiments of the present invention without paying any creative work all belong to the protection scope of the present invention.

Optionally in this embodiment, the sum of the areas of the light shielding zones and the sum of the areas of the light transmissive zones in each column of grating regions can be equal, such that the sum of the areas of the sub-pixels shielded by the light shielding zones and the sum of the areas of the sub-pixels exposed by the light transmissive zones in each column of sub-pixel regions are equal, thereby the rate of resolution decrease in the column direction is 50%, which is benefit for further reducing the difference between the rates of resolution decrease in the row direction and the column direction, so as to mitigate or eliminate graininess of 3D images.

Further, the sub-pixels of the display panel can be arranged in a plurality of rows, each row comprising a plurality of arrangement cycles, the colors of the sub-pixels in each arrangement cycle are different from one another, when being driven, the first sub-pixels and the second sub-pixels in each row are arranged alternately, and the light shielding zones and the light transmissive zones in each row of grating regions in the parallax barrier are arranged alternately, so that the sum of the areas of the light shielding zones and the sum of the areas of the light transmissive zones in each row of grating regions are equal, and the sum of the areas of sub-pixels shielded by the light shielding zones and the sum of the areas of sub-pixels exposed by the light transmissive zones in each row of sub-pixel regions are equal, thereby making the rate of resolution decrease in the row direction to be 50%.

The inventor finds from further study that the problem of fuzzy image in 3D display is particularly serious in the 3D display device using a liquid crystal grating in which the conventional strip-shaped light shielding zones and light transmissive zones are obliquely (i.e., in an angle with the column direction of sub-pixel arrangement) arranged, one of the reasons that result in this phenomenon lies in:

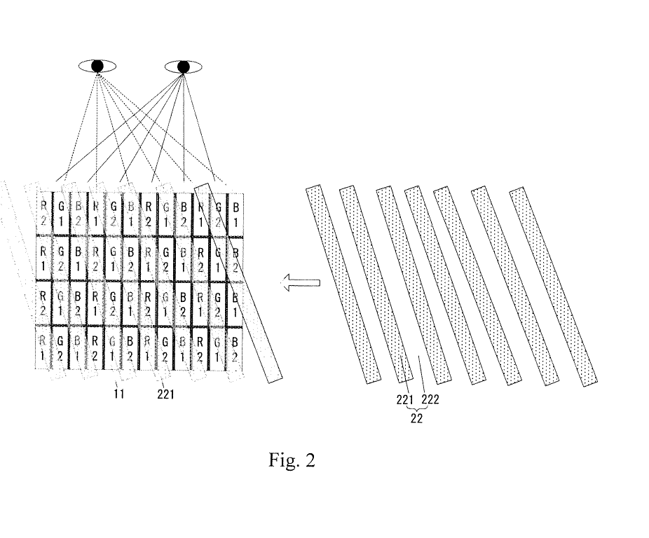

As shown in FIG. 2, the light shielding zones 221 (in order to show the shielding effect of the light shielding zones 221 to the sub-pixels, translucent processing is performed to the light shielding zones 221 in the view at the left side of FIG. 2) and the light transmissive zones 222 in the liquid crystal grating 22 are in strip shape, the light shielding zones 221 and the light transmissive zones 222 are arranged obliquely and alternately, for the left eye of the observer, the light transmissive zones 222 expose most of the sub-pixels that display the left eye image, meanwhile, the light transmissive zones 222 may further expose a small part of the sub-pixels that display the right eye image, while for the right eye of the observer, the light transmissive zones 222 expose most of the sub-pixels that display the right eye image, meanwhile, the light transmissive zones 222 may further expose a small part of the sub-pixels that display the left eye image, thereby resulting in the light of the right eye image mixed in the light of the left eye image, and the light of the left eye image mixed in the light of the right eye image, which results in image crosstalk and fuzzy display, and the display quality is reduced.

Based on this finding, the inventor makes further improvement to the structure of the parallax barrier on the basis of the preceding 3D display device and the driving method thereof that can eliminate image graininess, such that for the left eye of the observer, each light shielding zone shields one of the second sub-pixels, each light transmissive zone exposes one of the first sub-pixels; for the right eye of the observer, each light shielding zone shields one of the first sub-pixels, each light transmissive zone exposes one of the second sub-pixels, i.e., the light shielding zone shields the light of the left eye image or the light of the right eye image completely, the light transmissive zone only transmits the light of the right eye image or the light of the left eye image, thus avoiding the problem crosstalk between the left and right eye images caused by mixing the light of the left eye image in the light of the right eye image and mixing the light of the right eye image in the light of the left eye image due to the angle between the light shielding zone and the light transmissive zone and the column direction of the sub-pixel arrangement, so as to improve clarity of the 3D display image and improve the display quality.

Next, the 3D display device and the driving method thereof provided by this embodiment will be introduced specifically.

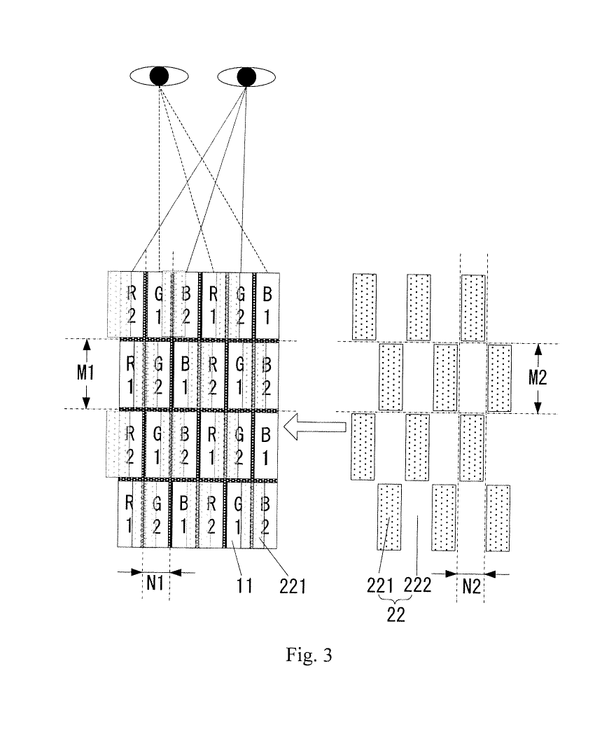

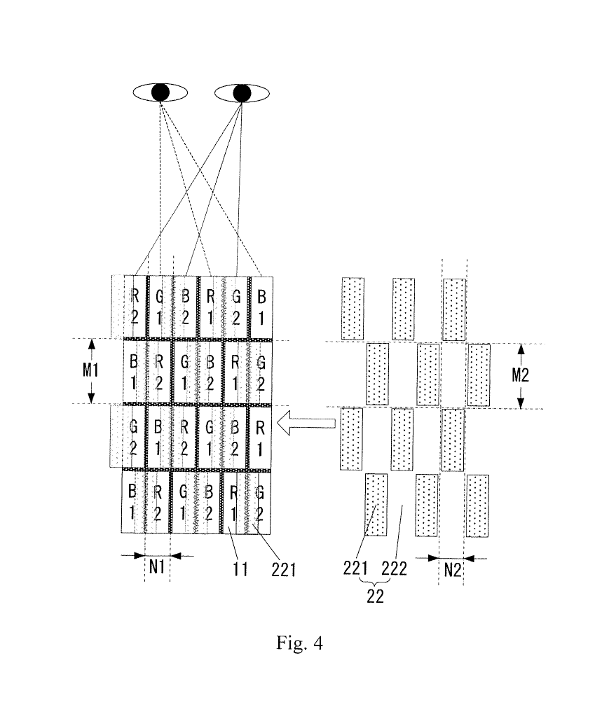

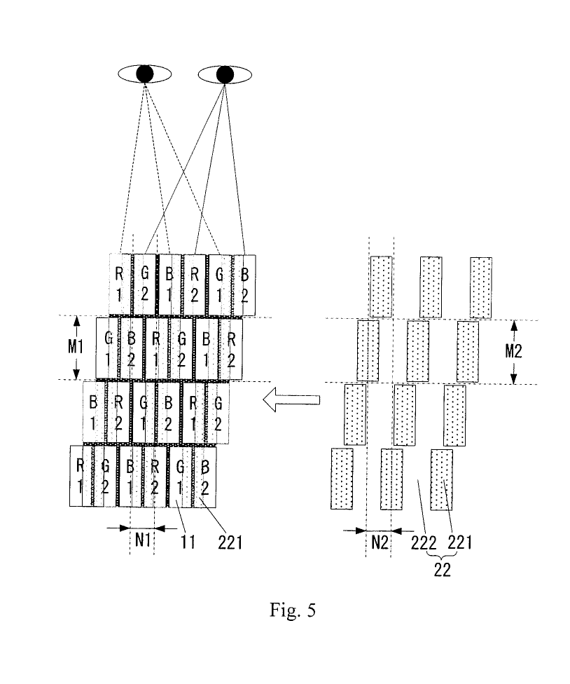

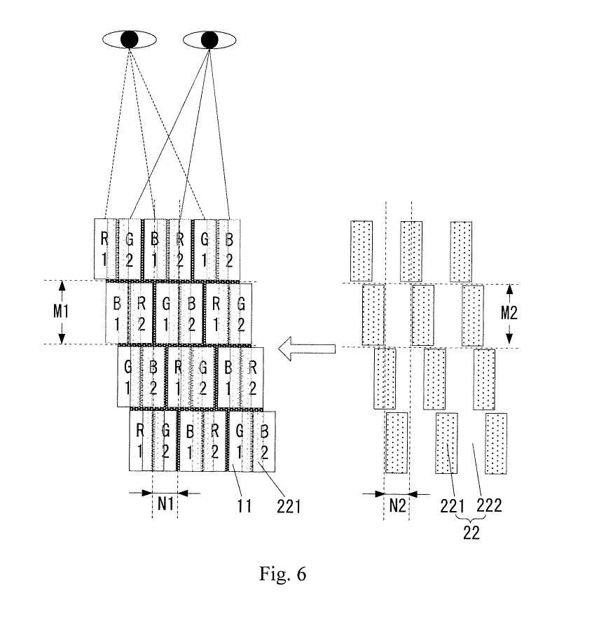

It should be noted that FIG. 3˜FIG. 8 all only show the corresponding cases of a pixel period (including totally 24 sub-pixels in 4 rows and 6 columns) and a grating period (including 12 light shielding zones 221 and 12 light transmissive zones 222), the sub-pixels in the display panel are arranged by taking the pixel period as shown in the figures as a repeat period, the light shielding zones 221 and the light transmissive zones 222 in the parallax barrier 22 are arranged by taking the grating period as shown in the figures as a repeat period.

Moreover, what are shown at the right sides of FIG. 3˜FIG. 8 are relative positional relationship between the perpendicular projection of the parallax barrier 22 on the display panel and the sub-pixels 11, generally, the perpendicular projections of the light shielding zones 221 of the parallax barrier 22 on the display panel overlap with two adjacent sub-pixels (a first sub-pixel and a second sub-pixel) respectively, optionally, the light shielding zones 221 overlap with respective half of two adjacent sub-pixels respectively.

In addition, in order to represent the shielding effect of the light shielding zones 221 to the sub-pixels 11 clearly, translucent processing is performed to the light shielding zones 221 in the view of the left sides of FIG. 3˜FIG. 8.

Optionally in this embodiment, the sum of the areas of the light shielding zones and the sum of the areas of the light transmissive zones in each column of grating regions can be equal, such that the sum of the areas of the sub-pixels shielded by the light shielding zones and the sum of the areas of the sub-pixels exposed by the light transmissive zones in each column of sub-pixel regions are equal, thereby the rates of resolution decrease in the row direction and the column direction are both 50%, the difference between the two is reduced to 0, thus, the problem of image graininess caused by large difference between of the rates of resolution decrease in the row direction and the column direction can be eliminated completely.

Specifically, as shown in FIG. 3, the sub-pixels 11 of the display panel are arranged in a matrix, each row comprising a plurality of arrangement cycles, the colors of the sub-pixels in each arrangement cycle are different from one another (for example, the sub-pixels in each arrangement cycle are arranged in the order of RGBRGB), all the sub-pixels in each column have the same color (for example, the color of each column of sub-pixels is R or G or B), when being driven, the first sub-pixels and the second sub-pixels in each row are arranged alternately, the first sub-pixels and the second sub-pixels in each column are also arranged alternately; the light shielding zones 221 and the light transmissive zones 222 in each row of grating regions M2 in the parallax barrier 22 are arranged alternately, the light shielding zones 221 and the light transmissive zones 222 in each column of grating regions N2 are arranged alternately. Due to the shielding effect of the parallax barrier 22 to the sub-pixels 11, the light of the left eye image all enters into the left eye, the light of the right eye image all enters into the right eye, thereby generating a 3D display effect.

In one grating period as shown in FIG. 3, the sum of the areas of the shielding zones 221 and the sum of the areas of the light transmissive zones 222 in each row of grating regions M2 are both 3 (suppose that the areas of a unit light shielding zone 221 and a unit light transmissive zone 222 are both 1), the sum of the areas of the shielding zones 221 and the sum of the areas of the light transmissive zones 222 in each column of grating regions N2 are both 2, in one pixel period, the areas of 3 sub-pixels are shielded and the areas of 3 sub-pixels are exposed in each row of sub-pixel regions M1, the areas of 2 sub-pixels are shielded and the areas of 2 sub-pixels are exposed in each column of pixel regions N1, such that the area of the sub-pixels shielded in the row direction is half of the area of the whole row, the area of the sub-pixels shielded in the column direction is half of the area of the whole column, thus the rates of resolution decrease in the row direction and the column direction are both 50%, the image has no graininess.

In addition, since the light shielding zones 221 and the light transmissive zones 222 are both in one-to-one correspondence with the sub-pixels, the light transmitted from the light transmissive zones 222 is only the light of the left eye image or the light of the right eye image, crosstalk will not occur to the left and right eye images, and the image display is clear.

As shown in FIG. 4, the sub-pixels 11 of the display panel are arranged in a matrix, each row comprising a plurality of arrangement cycles, the colors of the sub-pixels in each arrangement cycle are different from one another, adjacent sub-pixels in each column have different colors, when being driven, the first sub-pixels and the second sub-pixels in each row are arranged alternately, the first sub-pixels and the second sub-pixels in each column are arranged alternately; the light shielding zones 221 and the light transmissive zones 222 in each row of grating regions M2 in the parallax barrier 22 are arranged alternately, the light shielding zones 221 and the light transmissive zones 222 in each column of grating regions N2 are arranged alternately. The 3D display device can also eliminate the problems of image graininess and image crosstalk on the basis of realizing 3D display, further, since each row of sub-pixel regions M1 and each column of sub-pixel regions N1 both have sub-pixels of different colors, the image has a better color mixing effect.

As shown in FIG. 5, adjacent sub-pixels in the column direction in the display panel have different colors, a next row of sub-pixels shift to the left for an amount less than the width of a unit sub-pixel relative to a previous row of sub-pixels, the shift amount optionally may be half to one of the width of a unit sub-pixel (this value range includes the left end point, not including the right end point, i.e., the shift amount may be greater than and equal to half of the width of a unit sub-pixel and less than the width of a unit sub-pixel), if the shift amount is half of the width of a unit sub-pixel, the sub-pixels will be arranged in a Chinese character “ [symbol] ” shape; when being driven, the first sub-pixels in a next row shift to the left for an amount less than the width of a unit sub-pixel relative to the first sub-pixels in a previous row, the second sub-pixels in a next row also shift to the left for an amount less than the width of a unit sub-pixel relative to the second sub-pixels in a previous row, the shift amount optionally may be same as the preceding shift amount, the light shielding zones 221 in a next row of grating regions shift to the left for an amount less than the width of a unit light shielding zone relative to the light shielding zones 221 in a previous row of grating regions in the parallax barrier 22, the shift amount optionally may be half to one of the width of a unit light shielding zone (this value range includes the left end point, not including the right end point, i.e., the shift amount may be greater than and equal to half of the width of a unit light shielding zone and less than the width of a unit light shielding zone). Further, the proportion of the corresponding shift amount of the light shielding zone in the width of a unit light shielding zone is same as the proportion of the corresponding shift amount of the sub-pixel in the width of a unit sub-pixel. Similarly, the light transmissive zones 222 in a next row of grating regions also shift to the left for an amount less than the width of a unit light shielding zone relative to the light transmissive zones 222 in a previous row of grating regions, the shift amount optionally may be same as the corresponding shift amount of the preceding light shielding zones. Due to the shielding effect of the parallax barrier 22 to the sub-pixels 11, the light of the left eye image all enters into the left eye, the light of the right eye image all enters into the right eye, thereby generating a 3D display effect.

In one grating period as shown in FIG. 5, the sum of the areas of the light shielding zones 221 and the sum of the areas of the light transmissive zones 222 in each row of grating regions M2 are both 3, the sum of the areas of the light shielding zones 221 and the sum of the areas of the light transmissive zones 222 in each column of grating regions N2 are both 2, in one pixel period, the areas of 3 sub-pixels are shielded and the areas of 3 sub-pixels are exposed in each row of sub-pixel regions M1, the area of one entire sub-pixel and the areas of two half sub-pixels are shielded and the area of one entire sub-pixel and the areas of two half sub-pixels are exposed in each column of sub-pixel regions N1, thereby the area of the sub-pixels shielded in the row direction is half of the area of the whole row, the area of the sub-pixels shielded in the column direction is half of the area of the whole column, the rates of resolution decrease in the row direction and the column direction are both 50%, the image has no graininess.

In addition, since the light shielding zones 221 and the light transmissive zones 222 are both in one-to-one correspondence with the sub-pixels, the light transmitted from the light transmissive zones 222 is only the light of the left eye image or the light of the right eye image, crosstalk will not occur to the left and right eye images, and the image display is clear.

Meanwhile, since each row of sub-pixel regions M1 and each column of sub-pixel regions N1 both have sub-pixels of different colors, the image has a better color mixing effect.

Contrary to the case as shown in FIG. 5, as shown in FIG. 6, adjacent sub-pixels in the column direction in the display panel have different colors, a next row of sub-pixels shift to the right for an amount less than the width of a unit sub-pixel relative to a previous row of sub-pixels, when being driven, the first sub-pixels in the next row shift to the right relative to the first sub-pixels in the previous row, the second sub-pixels in the next row also shift to the right relative to the second sub-pixels in the previous row, the light shielding zones 221 in the next row of grating regions shift to the right relative to the light shielding zones 221 in the previous row of grating regions in the parallax barrier 22, similarly, the light transmissive zones 222 in the next row of grating regions also shift to the right relative to the light transmissive zones 222 in the previous row of grating regions. The 3D display device can eliminate the problems of image graininess and image crosstalk on the basis of realizing 3D display, and the image has a better color mixing effect.

According to the embodiments of the present invention, the ratio of the sum of the areas of the light shielding zones and the sum of the areas of the light transmissive zones in the odd column of grating regions may be 1:3, the ratio of the sum of the areas of the light shielding zones and the sum of the areas of the light transmissive zones in the even column of grating regions may be 3:1, such that the ratio of a sum of areas of the sub-pixels shielded by the light shielding zones and a sum of areas of the sub-pixels exposed by the light transmissive zones in odd columns of sub-pixel regions is 1:3, the ratio of a sum of areas of the sub-pixels shielded by the light shielding zones and a sum of areas of the sub-pixels exposed by the light transmissive zones in even columns of sub-pixel regions is 3:1, thereby the ratio of resolution decrease of the odd columns in the column direction is 25%, the rate of resolution decrease of the even columns is 75%, the differences of the two from the rate (50%) of resolution decrease in the row direction are both 25%, which is greatly reduced relative to the original difference (50%) between the rates of resolution decrease in the row direction and the column direction, the problem of image graininess can be mitigated or eliminated effectively.

Specifically, as shown in FIG. 7, adjacent sub-pixels in the column direction in the display panel have different colors, the even rows (rows p2, p4, p6 within one sub-pixel period) of sub-pixels shift to the left relative to the odd rows (rows p1, p3, p5 within one sub-pixel period) of sub-pixels, the shift amount optionally may be half to one of the width of a unit sub-pixel (this value range includes the left end point, not including the right end point, i.e., the shift amount may be greater than and equal to half of the width of a unit sub-pixel and less than the width of a unit sub-pixel), if the shift amount is half of the width of a unit sub-pixel, the sub-pixels are arranged in a Chinese character “ [symbol] ” shape; when being driven, the first sub-pixels in even rows also shift to the left relative to the first sub-pixels in the odd rows, the second sub-pixels in the even rows also shift to the left relative to the second sub-pixels in the odd rows, the shift amount may be same as the preceding shift amount, the light shielding zones in the even rows of grating regions (rows q2, q4, q6 within one grating period) shift to the left relative to the light shielding zones in odd rows (rows q1, q3, q5 within one grating period) of grating regions in the parallax barrier, the shift amount optionally may be half to one of the width of a unit light shielding zone (this value range includes the left end point, not including the right end point, i.e., the shift amount may be greater than and equal to half of the width of a unit light shielding zone and less than the width of a unit light shielding zone). Further, the proportion of the corresponding shift amount of the light shielding zone in the width of a unit light shielding zone is same as the proportion of the corresponding shift amount of the sub-pixel in the width of a unit sub-pixel, similarly, the light transmissive zones in even rows of grating regions also shift to the left relative to the light transmissive zones in odd rows of grating regions, the shift amount may be same as the corresponding shift amount of the preceding light shielding zones. Due to the shielding effect of the parallax barrier 22 to the sub-pixels 11, the light of the left eye image all enters into the left eye, the light of the right eye image all enters into the right eye, thereby generating a 3D display effect.

In one grating period as shown in FIG. 7, the sum of the areas of the light shielding zones 221 and the sum of the areas of the light transmissive zones 222 in each row of grating regions M2 are both 3, the sum of the areas of the light shielding zones 221 in odd columns of grating regions N2 is 1, the sum of the areas of the light transmissive zones 222 is 3, the sum of the areas of the light shielding zones 221 in even columns of grating regions N2 is 3, the sum of the areas of the light transmissive zones 222 is 1. In one pixel period, the areas of 3 sub-pixels are shielded and the areas of 3 sub-pixels are exposed in each row of sub-pixel regions M1, the areas of two half sub-pixels are shielded and the areas of two entire sub-pixels and two half sub-pixels are exposed in odd columns of sub-pixel regions N1, the areas of two entire sub-pixels and the areas of two half sub-pixels are shielded and the areas of two half sub-pixels are exposed in even columns of sub-pixel regions N1, thereby, the area of the sub-pixels shielded in the row direction is half of the area of the whole row, the area of the shielded sub-pixels of odd columns in the column direction is quarter of the area of the whole column, the area of the shielded sub-pixels of even columns is three-quarter of the area of the whole column, the rate of resolution decrease in the row direction is 50%, the rates of resolution decrease in odd column direction and even column direction are 25% and 75% respectively, the difference between the rates of resolution decrease in the row direction and the column direction is reduced to 25%, the image graininess is mitigated or eliminated.

In addition, since the light shielding zones 221 and the light transmissive zones 222 are both in one-to-one correspondence with the sub-pixels, the light transmitted from the light transmissive zones 222 is only the light of the left eye image or the light of the right eye image, crosstalk will not occur to the left and right eye images, and the image display is clear.

Meanwhile, since each row of sub-pixel regions M1 and each column of sub-pixel regions N1 both have sub-pixels of different colors, the image has a better color mixing effect.

Contrary to the case as shown in FIG. 7, as shown in FIG. 8, adjacent sub-pixels in the column direction in the display panel have different colors, the even rows (rows p2, p4, p6 within one sub-pixel period) of sub-pixels shift to the right for an amount less than the width of a unit sub-pixel relative to the odd rows (rows p1, p3, p5 within one sub-pixel period) of sub-pixels, when being driven, the first sub-pixels in the even rows shift to the right for an amount less than the width of a unit sub-pixel relative to the first sub-pixels in the odd rows, the second sub-pixels in the even rows also shift to the right for an amount less than the width of a unit sub-pixel relative to the second sub-pixels in the odd rows, the light shielding zones in the even rows of grating regions (rows q2, q4, q6 within one grating period) shift to the right for an amount less than the width of a unit light shielding zone relative to the light shielding zones in odd rows (rows q1, q3, q5 within one grating period) of grating regions in the parallax barrier, similarly, the light transmissive zones in even rows of grating regions also shift to the right for an amount less than the width of a unit light shielding zone relative to the light transmissive zones in the odd rows of grating regions. The 3D display device can also eliminate the problems of image graininess and image crosstalk on the basis of realizing 3D display, and the image has a better color mixing effect.

It should be noted that the preceding “odd columns” and “even columns” are only used for distinguishing two adjacent columns of sub-pixel regions N1 or grating regions N2, and representing the corresponding relationship between the grating regions and the sub-pixel regions, the actual positions of the sub-pixel regions N1 and the grating regions N2 should not be restricted, hence, the preceding statement that “the ratio of a sum of areas of the light shielding zones and a sum of areas of the light transmissive zones in odd columns of grating regions is 1:3, the ratio of a sum of areas of the light shielding zones and a sum of areas of the light transmissive zones in even columns of grating regions is 3:1” actually means that the ratio of a sum of areas of the light shielding zones and a sum of areas of the light transmissive zones in one of two adjacent columns of grating regions N2 is 1:3, the ratio of a sum of areas of the light shielding zones and a sum of areas of the light transmissive zones in the other column is 3:1. Similarly, the preceding statement that “the ratio of a sum of areas of the sub-pixels shielded by the light shielding zones and a sum of areas of the sub-pixels exposed by the light transmissive zones in odd columns of sub-pixel regions is 1:3, the ratio of a sum of areas of the sub-pixels shielded by the light shielding zones and a sum of areas of the sub-pixels exposed by the light transmissive zones in even columns of sub-pixel regions is 3:1” actually means that the ratio of a sum of areas of the sub-pixels shielded by the light shielding zones and a sum of areas of the sub-pixels exposed by the light transmissive zones in the sub-pixel regions to which each column of grating regions in which the ratio of a sum of areas of the sub-pixels shielded by the light shielding zones and a sum of areas of the sub-pixels exposed by the light transmissive zones is 1:3 corresponds is 1:3, the ratio of a sum of areas of the sub-pixels shielded by the light shielding zones and a sum of areas of the sub-pixels exposed by the light transmissive zones in the sub-pixel regions to which each column of grating regions in which the ratio of a sum of areas of the light shielding zones and a sum of areas of the light transmissive zones is 3:1 corresponds is 3:1.

In addition, in FIG. 3˜FIG. 8, the sub-pixels are arranged in a Chinese character “ [symbol] ” shape, adjacent pixels may share the sub-pixels, these kinds of pixel arrangements can combine with the virtual pixel technology to generate more pixel points than the pixels arranged in a matrix, which improves the display resolution effectively. Optionally, for the three sub-pixels arranged in a Chinese character “ [symbol] ” shape, their colors may be R, G, B respectively.

On the other hand, this embodiment only takes the above several specific structures and the driving method thereof as examples to introduce the 3D display device provided therein, with the core idea of the present invention unchanged, the skilled person in the art can make appropriate variants or modification to obtain other structures of the parallax barrier, pixel arrangements and driving methods on the basis of this, so as to improve display quality.

In this embodiment, the display panel optionally may comprise sub-pixels of three colors of red, green and blue. The ratio of the width and the length of the sub-pixel may be 1:3˜1:1, such as 1:3, 1:2, 1:1.5 or 1:1, which will not be restricted here.

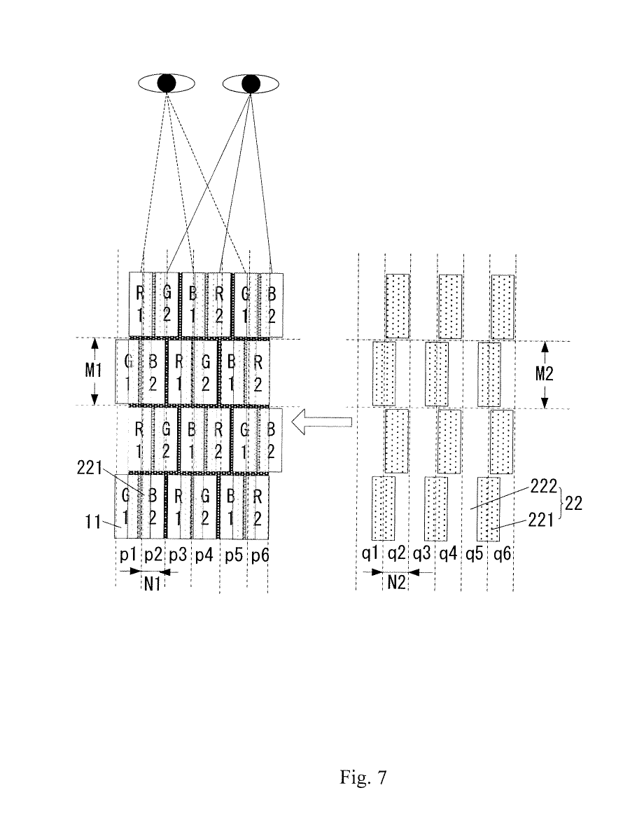

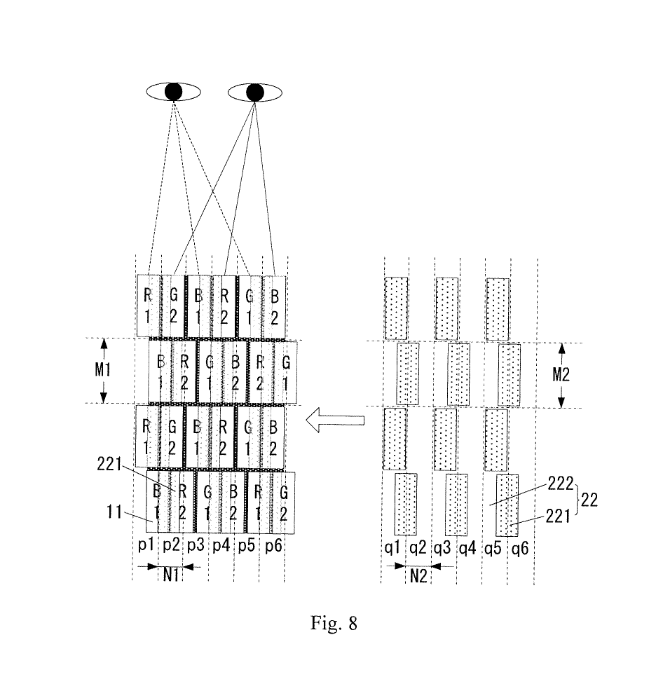

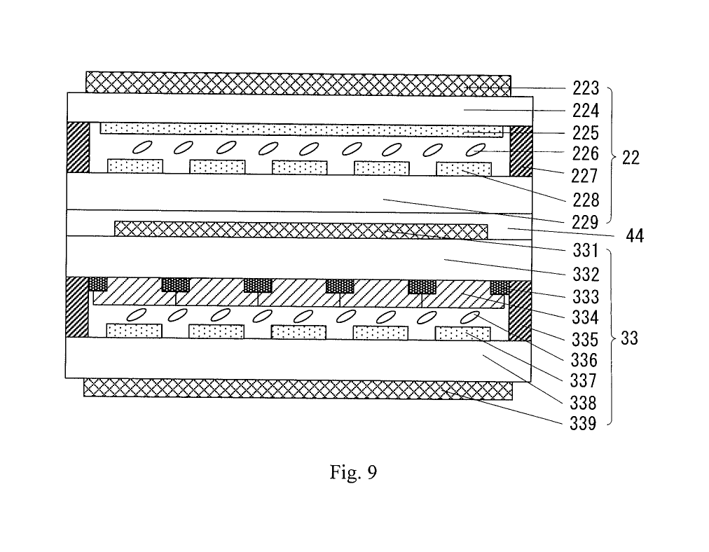

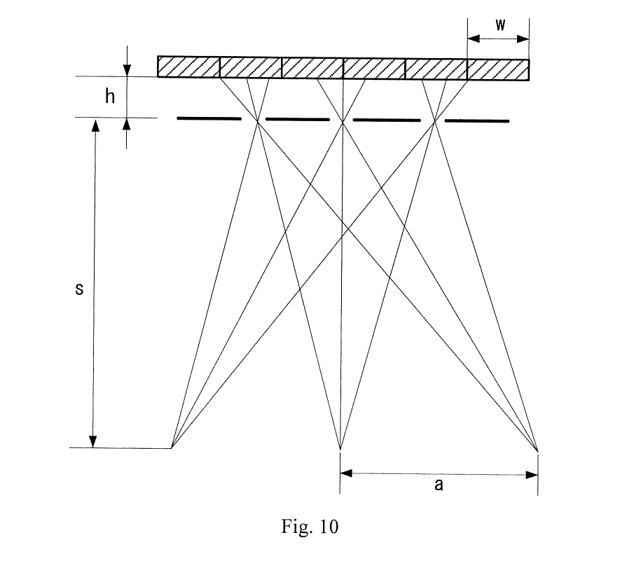

The parallax barrier as stated in this embodiment optionally may be a liquid crystal grating, the preparation of the liquid crystal grating is compatible with the preparation of the display panel, such that the preparation process of the whole 3D display device is more mature, and the preparation process becomes simpler. On the basis of this, a specific structure of the 3D display device provided by this embodiment will be provided below. As shown in FIG. 9, the 3D display device may comprise: a parallax barrier 22 (preferably a liquid crystal grating) and a display panel 33, the two are superposed together through an optical adhesive 44. Wherein, the structure of the parallax barrier 22 is: the inner side of the substrate 224 is provided with a first electrode layer 225, the outer side is provided with a polarizer 223, the inner side of the substrate 229 is provided with a second electrode layer 228, the substrates 224 and 229 are opposite to each other, a liquid crystal layer 226 is filled between the two, and the two are sealed with sealing frame glue 227 at the peripheral; the structure of the display panel 33 is: the inner side of the substrate 332 is provided with a black matrix 333 and a color resin 334, the outer side is provided with a polarizer 331, the inner side of the substrate 338 is provided with a pixel electrode 337, the outer side is provided with a polarizer 339, the substrates 332 and 338 are opposite to each other, a liquid crystal layer 336 is filled between the two, and the two are sealed with sealing frame glue 335 at the peripheral; the parallax barrier 22 and the display panel 33 share the polarizer 331; the display driving module and the barrier driving module of this 3D display device can be integrated on a driving circuit board outside the display panel 33 and the parallax barrier 22, which is not shown in the figure.

The parallax barrier stated in this embodiment may also be a grating in the form of electrochromism, the structure of the grating in the form of electrochromism mainly comprises: an electrochromic layer and a first electrode layer and a second electrode layer arranged at opposite sides of the electrochromic layer respectively. It should be noted that the electrochromic layer is formed by electrochromic material, which can change color under the effect of the electric field, thereby forming light shielding zones and light transmissive zones displayed in black and white alternately. In addition, in this embodiment, the electrochromic layer as well as the first electrode layer and the second electrode layer may be sandwiched between two glass substrates to form a parallax barrier, and the formed parallax barrier is superposed at the outer side of the display panel in the form of plug-in, or the electrochromic layer as well as the first electrode layer and the second electrode layer may be arranged between the upper substrate and the upper polarizer of the display panel in the form of on-cell, so as to save the use amount of the substrate and reduce the thickness of the device.

For a parallax barrier in the form of liquid crystal or in the form of electrochromism, the barrier driving module of the 3D display device provided by this embodiment may be specifically used for outputting a first driving voltage signal and a second driving voltage signal; correspondingly, the first electrode layer 225 of the parallax barrier 22 receives the first driving voltage signal, the second electrode layer 228 receives the second driving voltage signal, thereby generating a voltage difference between the first electrode layer 225 and the second electrode layer 228, which facilitates the liquid crystal molecules in the corresponding regions to be deflected or the electrochromic material to change color, thereby forming desired light shielding zones and light transmissive zones. Optionally, the first electrode layer 225 may be a planar electrode in whole, the second electrode layer 228 may be a slit electrode, which may be same as the pattern of the light shielding zone or the light transmissive zone to be formed specifically, so as to form required light shielding zones and light transmissive zones.

The 3D display device provided by this embodiment is a bare 3D display device, which requires no glasses, the 3D images can be observed only by standing within an appropriate distance range. The visual distance of the 3D image can be obtained from the formula s=h×a/w by calculation, wherein s represents the visual distance of the 3D image (i.e., the perpendicular distance from the observer to the 3D display device), h represents the space between the parallax barrier and the display panel, a represents the distance between the left and right eyes (generally about 65 mm), w represents the width of a unit pixel (i.e., the space between the central lines in the column direction of adjacent pixels in each row).

It should be noted that the display panel of the 3D display device provided by this embodiment may be a liquid crystal panel, and may also be an organic light-emitting diode (OLED) panel, the 3D display device may be used in any products or components with the display function, such as mobile phone, tablet computer, television, display, laptop, digital photo frame, navigator etc.

What are stated above are only specific implementing modes of the present invention, however, the protection scope of the present invention is not limited to this, any modifications or replacements that can be easily conceived by the skilled person familiar with the present technical field within the technical scope disclosed by the present invention should be covered within the protection scope of the present invention. Therefore, the protection scope of the present invention should be based on the protection scopes of the claims as attached.

1. A 3D display device comprising:
a display driving module for outputting a left eye image signal and a right eye image signal;
a display panel connected with the display driving module, comprising a plurality of sub-pixels, one part of the plurality of sub-pixels receiving the left eye image signal, the other part of the plurality of sub-pixels receiving the right eye image signal; the sub-pixels receiving the left eye image signal being first sub-pixels, the sub-pixels receiving the right eye image signal being second sub-pixels;
a barrier driving module for outputting a driving voltage signal;
a parallax barrier connected with the barrier driving module and superposed on the display panel, the parallax barrier comprising a plurality of grating regions, the plurality of grating regions forming a plurality of light shielding zones and a plurality of light transmissive zones under the driving of the driving voltage signal, such that, for the left eye of an observer, respective light shielding zones shield respective second sub-pixels and respective light transmissive zones expose respective first sub-pixels, for the right eye of an observer, respective light shielding zones shield respective first sub-pixels and respective light transmissive zones expose respective second sub-pixels;
wherein a sum of areas of the light shielding zones and a sum of areas of the light transmissive zones in each row of grating regions are both greater than 0, a sum of areas of the light shielding zones and a sum of areas of the light transmissive zones in each column of grating regions are both greater than 0, such that a sum of areas of sub-pixels shielded by the light shielding zones and a sum of areas of sub-pixels exposed by the light transmissive zones in each row of sub-pixel regions are both greater than 0, a sum of areas of sub-pixels shielded by the light shielding zones and a sum of areas of sub-pixels exposed by the light transmissive zones in each column of sub-pixel regions are both greater than 0; and
wherein the width of each row of grating regions is equal to the length of a unit light shielding zone, the width of each column of grating regions is equal to the width of a unit light shielding zone, the width of each row of sub-pixel regions is equal to the length of a unit sub-pixel, the width of each column of sub-pixel regions is equal to the width of a unit sub-pixel.

2. The 3D display device according to claim 1, wherein the sum of the areas of the light shielding zones and the sum of the areas of the light transmissive zones in each row of grating regions are equal, such that the sum of the areas of the sub-pixels shielded by the light shielding zones and the sum of the areas of the sub-pixels exposed by the light transmissive zones in each row of sub-pixel regions are equal.

3. The 3D display device according to claim 2, wherein, for the left eye of the observer, one light shielding zone shields one second sub-pixel, one light transmissive zone exposes one first sub-pixel;
for the right eye of the observer, one light shielding zone shields one first sub-pixel, one light transmissive zone exposes a second sub-pixel.

4. The 3D display device according to claim 3, wherein the sub-pixels of the display panel are arranged in a plurality of rows, each row comprising a plurality of arrangement cycles, the colors of the sub-pixels in each arrangement cycle are different from one another, the first sub-pixels and the second sub-pixels in each row are arranged alternately;
the light shielding zones and the light transmissive zones in each row of grating regions in the parallax barrier are arranged alternately.

5. The 3D display device according to claim 4, wherein the sum of the areas of the light shielding zones and the sum of the areas of the light transmissive zones in each column of grating regions are equal, such that the sum of the areas of the sub-pixels shielded by the light shielding zones and the sum of the areas of the sub-pixels exposed by the light transmissive zones in each column of sub-pixel regions are equal.

6. The 3D display device according to claim 5, wherein the sub-pixels of the display panel are arranged in a matrix, all the sub-pixels in each column have the same color, the first sub-pixels and the second sub-pixels in each column are arranged alternately;
the light shielding zones and the light transmissive zones in each column of grating regions in the parallax barrier are arranged alternately.

7. The 3D display device according to claim 5, wherein the sub-pixels of the display panel are arranged in a matrix, adjacent sub-pixels in each column have different colors, the first sub-pixels and the second sub-pixels in each column are arranged alternately;
the light shielding zones and the light transmissive zones in each column of grating regions in the parallax barrier are arranged alternately.

8. The 3D display device according to claim 4, wherein adjacent sub-pixels of the display panel in the column direction have different colors, a next row of sub-pixels shift to the left for an amount less than the width of a unit sub-pixel relative to a previous row of sub-pixels; light shielding zones in a next row of grating regions shift to the left for an amount less than the width of a unit light shielding zone relative to light shielding zones in a previous row of grating regions in the parallax barrier.

9. The 3D display device according to claim 4, wherein adjacent sub-pixels of the display panel in the column direction have different colors, a next row of sub-pixels shift to the right for an amount less than the width of a unit sub-pixel relative to a previous row of sub-pixels; light shielding zones in a next row of grating regions shift to the right for an amount less than the width of a unit light shielding zone relative to light shielding zones in a previous row of grating regions in the parallax barrier.

10. The 3D display device according to claim 4, wherein the ratio of a sum of areas of the light shielding zones and a sum of areas of the light transmissive zones in odd columns of grating regions is 1:3, the ratio of a sum of areas of the light shielding zones and a sum of areas of the light transmissive zones in even columns of grating regions is 3:1, such that the ratio of a sum of areas of the sub-pixels shielded by the light shielding zones and a sum of areas of the sub-pixels exposed by the light transmissive zones in odd columns of sub-pixel regions is 1:3, the ratio of a sum of areas of the sub-pixels shielded by the light shielding zones and a sum of areas of the sub-pixels exposed by the light transmissive zones in even columns of sub-pixel regions is 3:1.

11. The 3D display device according to claim 10, wherein adjacent sub-pixels of the display panel in the column direction have different colors, even rows of sub-pixels shift to the left for an amount less than the width of a unit sub-pixel relative to odd rows of sub-pixels; light shielding zones in even rows of grating regions shift to the left for an amount less than the width of a unit light shielding zone relative to light shielding zones in odd rows of grating regions in the parallax barrier.

12. The 3D display device according to claim 10, wherein adjacent sub-pixels of the display panel in the column direction have different colors, even rows of sub-pixels shift to the right for an amount less than the width of a unit sub-pixel relative to odd rows of sub-pixels; light shielding zones in even rows of grating regions shift to the right for an amount less than the width of a unit light shielding zone relative to light shielding zones in odd rows of grating regions in the parallax barrier.

13. The 3D display device according to claim 1, wherein the display panel comprises sub-pixels of three colors of red, green and blue.

14. The 3D display device according to claim 1, wherein the ratio of the width and the length of the sub-pixel is 1:3˜1:1.

15. The 3D display device according to claim 1, wherein the barrier driving module is used for outputting a first driving voltage signal and a second driving voltage signal;
the parallax barrier comprises a liquid crystal layer and a first electrode layer and a second electrode layer arranged at two sides of the liquid crystal layer respectively;
wherein the first electrode layer receives the first driving voltage signal, and the second electrode layer receives the second driving voltage signal.

16. The 3D display device according to claim 1, wherein the barrier driving module is used for outputting a first driving voltage signal and a second driving voltage signal;
the parallax barrier comprises an electrochromic layer and a first electrode layer and a second electrode layer arranged at two sides of the electrochromic layer respectively;
wherein the first electrode layer receives the first driving voltage signal, and the second electrode layer receives the second driving voltage signal.

17. A driving method of a 3D display device, the 3D display device comprising: a display driving module for outputting a left eye image signal and a right eye image signal; a display panel connected with the display driving module, comprising a plurality of sub-pixels, one part of the plurality of sub-pixels receiving the left eye image signal, the other part of the plurality of sub-pixels receiving the right eye image signal; the sub-pixels receiving the left eye image signal being first sub-pixels, the sub-pixels receiving the right eye image signal being second sub-pixels; a barrier driving module for outputting a driving voltage signal; a parallax barrier connected with the barrier driving module and superposed on the display panel, the parallax barrier comprising a plurality of grating regions, the plurality of grating regions forming a plurality of light shielding zones and a plurality of light transmissive zones under the driving of the driving voltage signal, such that, for the left eye of an observer, respective light shielding zones shield respective second sub-pixels and respective light transmissive zones expose respective first sub-pixels, for the right eye of an observer, respective light shielding zones shield respective first sub-pixels and respective light transmissive zones expose respective second sub-pixels; the driving method comprising:
applying a left eye image signal to one part of sub-pixels of the display panel of the 3D display device, applying a right eye image signal to the other part of sub-pixels of the display panel of the 3D display device; the sub-pixels applied with the left eye image signal being first sub-pixels, the sub-pixels applied with the right eye image signal being second sub-pixels;
applying a driving voltage signal to the parallax barrier of the 3D display device, to enable the plurality of grating regions of the parallax barrier to form a plurality of light shielding zones and a plurality of light transmissive zones, such that, for the left eye of an observer, respective light shielding zones shield respective second sub-pixels and respective light transmissive zones expose respective first sub-pixels, for the right eye of an observer, respective light shielding zones shield respective first sub-pixels and respective light transmissive zones expose respective second sub-pixels;
wherein a sum of areas of the light shielding zones and a sum of areas of the light transmissive zones in each row of grating regions are both greater than 0, a sum of areas of the light shielding zones and a sum of areas of the light transmissive zones in each column of grating regions are both greater than 0, such that a sum of areas of sub-pixels shielded by the light shielding zones and a sum of areas of sub-pixels exposed by the light transmissive zones in each row of sub-pixel regions are both greater than 0, a sum of areas of sub-pixels shielded by the light shielding zones and a sum of areas of sub-pixels exposed by the light transmissive zones in each column of sub-pixel regions are both greater than 0; the width of each row of grating regions is equal to the length of a unit light shielding zone, the width of each column of grating regions is equal to the width of a unit light shielding zone, the width of each row of sub-pixel regions is equal to the length of a unit sub-pixel, the width of each column of sub-pixel regions is equal to the width of a unit sub-pixel.

18. The driving method of a 3D display device according to claim 17, wherein the sum of the areas of the light shielding zones and the sum of the areas of the light transmissive zones in each row of grating regions are equal, such that the sum of the areas of the sub-pixels shielded by the light shielding zones and the sum of the areas of the sub-pixels exposed by the light transmissive zones in each row of sub-pixel regions are equal.

19. The driving method of a 3D display device according to claim 18, wherein the sum of the areas of the light shielding zones and the sum of the areas of the light transmissive zones in each column of grating regions are equal, such that the sum of the areas of the sub-pixels shielded by the light shielding zones and the sum of the areas of the sub-pixels exposed by the light transmissive zones in each column of sub-pixel regions are equal.

20. The driving method of a 3D display device according to claim 17, wherein the ratio of a sum of areas of the light shielding zones and a sum of areas of the light transmissive zones in odd columns of grating regions is 1:3, the ratio of a sum of areas of the light shielding zones and a sum of areas of the light transmissive zones in even columns of grating regions is 3:1, such that the ratio of a sum of areas of the sub-pixels shielded by the light shielding zones and a sum of areas of the sub-pixels exposed by the light transmissive zones in odd columns of sub-pixel regions is 1:3, the ratio of a sum of areas of the sub-pixels shielded by the light shielding zones and a sum of areas of the sub-pixels exposed by the light transmissive zones in even columns of sub-pixel regions is 3:1.
